(19) United States
(12) Patent Application Publication
(10) Pub. No.: US 2025/0162346 A1
(43) Pub. Date: May 22, 2025

(54) Wheel Cover And Bicycle Wheel

(71) Applicant: Shenzhen Junyue Technology Co., Ltd., Shenzhen (CN)

(72) Inventor: Jinhao Zhang, Shenzhen (CN)

(21) Appl. No.: 18/528,751

(22) Filed: Dec. 4, 2023

(30) Foreign Application Priority Data
Nov. 16, 2023 (CN) 2023233081285X

(51) Int. Cl. B60B 7/00; B60B 7/08; B62J 43/30

(52) U.S. Cl. CPC B60B 7/006; B60B 7/08; B62J 43/30; B60B 2900/511

(57) ABSTRACT

Disclosed is a wheel cover arranged on a wheel of a bicycle and comprising a sealing disc, a light-emitting component arranged on an inner side of the sealing disc and a power supply component mounted on the sealing disc, wherein the sealing disc comprises first and second sealing discs respectively positioned at two sides of a hub of the bicycle, a via for the hub to pass through is formed on the sealing disc, the sealing disc is made of a transparent material, the power supply component is electrically connected to the light-emitting component, and the light-emitting component is fixed on the inner side of the sealing disc, covers the wheel through the sealing disc, and is mounted on the wheel without winding a light bar on a spoke, so that the mounting is more convenient, the wheel appearance is more aesthetic, and the displayed wheel effect is cooler.

### TECHNICAL FIELD

The present utility model relates to the technical field of bicycles, and in particular, to a wheel cover and a bicycle wheel.

### BACKGROUND

With the improvement of environmental protection and fitness consciousness of people, choosing bicycles for travel and exercise is highly praised by many people.

Cycling safety at night is an important issue. The spoke lights are mounted on the wheels of a bicycle, so that the wheels can shine to achieve the effect of position reminding for road lighting and bicycle warning, and a cool wheel cover effect is also achieved. In the conventional technology, the light cord is manually wrapped around the spokes of the bicycle, and then the light strip is connected to a battery box, and the battery box is fixed in the middle of the hub with additional rubber straps and other fasteners. This solution is difficult to mount and takes a long time to mount, and the corresponding lights are exposed outside, resulting in an unsightly appearance and inconvenient use.

### SUMMARY

A primary objective of the present utility model is to provide a wheel cover, which aims to overcome the defects that an existing light bar is directly wound around a bicycle spoke and the mounting is troublesome.

According to a first aspect, to achieve the objective, the present utility model provides a wheel cover, wherein the wheel cover is arranged on a wheel of a bicycle and comprises: a sealing disc, a light-emitting component arranged on an inner side of the sealing disc and a power supply component mounted on the sealing disc, wherein the sealing disc covers the wheel, a via for a bottom bracket to pass through is formed in the sealing disc, the sealing disc is made of a transparent material, the power supply component is electrically connected to the light-emitting component, and the light-emitting component is fixed on the inner side of the sealing disc.

Optionally, the light-emitting component comprises a connection terminal and at least two light strips, and the at least two light strips are connected in series or in parallel through the connection terminal.

Optionally, the connection terminal comprises a plug interface and a plug slot.

Optionally, each of the first sealing disc and the second sealing disc comprises at least two connecting units that are spliced, a clamping buckle and a clamping slot are arranged between adjacent connecting units, and the connecting units are connected and spliced by the clamping buckle and the clamping slot to form the sealing disc.

Optionally, the first sealing disc is provided with a hole corresponding to a position of a valve stem of the wheel, the inner side of the first sealing disc is provided with a clamping platform for clamping the valve stem, and the clamping platform is arranged on a lower side of the hole.

Optionally, the power supply component is arranged on the first sealing disc, the power supply component comprises a battery box and a battery, the battery box comprises a placement groove recessed toward a side of the wheel and a sealing cover flush with an outer surface of the sealing disc, and a first through hole for the light-emitting component to pass through is further formed in a bottom of the placement groove.

Optionally, at least one of the first sealing disc or the second sealing disc is provided with an abutment member, the abutment member is arranged on an inner side of the sealing disc, and the abutment member is configured to abut against a component of the wheel.

Optionally, the abutment member is arranged at a side that is of the battery box and that is adjacent to the wheel, and the abutment member is provided with a notch for abutting against the spoke.

Optionally, a plurality of first connecting members are arranged on an inner side of the first sealing disc, a plurality of second connecting members are correspondingly arranged on an inner side of the second sealing disc, and the first sealing disc and the second sealing disc are fixed by the first connecting members and the second connecting members.

Optionally, the first connecting member is an inserting post, and the second connecting member is an inserting aperture, wherein an outer edge of the inserting post or the inserting aperture is provided with side wings for abutting against an inner edge of the wheel.

Optionally, a groove is provided on the inner side of the sealing disc, and the light-emitting component is fixed in the groove.

Optionally, the sealing disc is provided with a flange for clamping with a wheel rim.

According to another aspect, this patent claims a bicycle wheel comprising the wheel cover according to any one of the preceding solutions, wherein the cover wheel is mounted on the bicycle wheel.

According to the present utility model, the sealing disc made of a transparent material is arranged, the light-emitting component is fixed on the inner side of the sealing disc and covers the wheel through the sealing disc, and the light-emitting component is mounted on the wheel without winding a light bar on a spoke, so that the mounting is more convenient, and the appearance of the wheel is more aesthetic. The bicycle wheel corresponding to the present utility model has a cooler effect.

### BRIEF DESCRIPTION OF DRAWINGS

To more clearly illustrate the technical solutions in the embodiments of the present utility model or in the prior art, the drawings required to be used in the description of the embodiments or the prior art are briefly introduced below. It is obvious that the drawings in the description below are only some embodiments of the present utility model, and those of ordinary skill in the art can obtain other drawings according to structures illustrated in these drawings without creative efforts.

FIG. 1 is a schematic diagram of a structure of an embodiment of a wheel cover according to the present utility model;

FIG. 2 is a schematic diagram of a structure of another embodiment of a wheel cover according to the present utility model;

FIG. 3 is a schematic diagram of an exploded structure of an embodiment of a wheel cover according to the present utility model;

FIG. 4 is an enlarged schematic diagram of B in FIG. 3;

FIG. 5 is a schematic diagram of an internal structure of another embodiment of a wheel cover according to the present utility model;

FIG. 6 is a schematic diagram of an exploded structure of another embodiment of a wheel cover according to the present utility model;

FIG. 7 is a schematic diagram of a structure of another embodiment of a wheel cover according to the present utility model;

FIG. 8 is an enlarged schematic diagram of A in FIG. 7; and

FIG. 9 is a schematic diagram of a structure of a connection terminal.

### DESCRIPTIONS OF REFERENCE NUMERALS

1: wheel cover; 10: sealing disc; 11: first sealing disc; 12: second sealing disc; 101: connecting unit; 102: via; 103: clamping buckle; 104: clamping slot; 13: hole; 131: clamping platform; 132: cover plate; 2: wheel; 21: bottom bracket; 22: hub; 23: valve stem; 24: spoke; 30: power supply component; 31: battery box; 32: first through hole; 40: abutment member; 41: notch; 50: inserting post; 51: side wing; 60: flange; 70: groove; 80: light-emitting component; 81: connection terminal; 811: plug interface; 812: plug slot; 82: light strip.

The realization of the objectives, the functional features, and the advantages of the present utility model will be further explained in conjunction with the embodiments and with reference to the drawings.

### DETAILED DESCRIPTION OF EMBODIMENTS

The technical solutions in the embodiments of the present utility model will be clearly and completely described below with reference to the drawings in the embodiments of the present utility model. It is apparent that the described embodiments are only some, but not all, embodiments of the present utility model. Based on the embodiments of the present utility model, all other embodiments obtained by those of ordinary skill in the art without creative efforts fall within the protection scope of the present utility model.

It should be noted that, if directional indications (such as upper, lower, left, right, front and rear) are involved in the embodiments of the present utility model, the directional indications are only used to explain the relative position relationships, the motion situations and the like between individual components under a certain pose (as shown in the drawings), and if the certain pose is changed, the directional indications are changed accordingly.

In addition, if there are descriptions relating to “first”, “second” and the like in the embodiments of the present utility model, the descriptions of “first”, “second” and the like are for descriptive purposes only and are not to be construed as indicating or implying relative importance thereof or implicitly indicating the quantities of technical features indicated. Thus, a feature defined by “first” or “second” may explicitly or implicitly include at least one such feature. In addition, “and/or” appearing herein is meant to include three parallel solutions, and taking “A and/or B” as an example, it includes solution A, or solution B, or both solution A and solution B. In addition, the technical solutions among various embodiments may be combined with each other, however, this combination must be based on that it can be realized by those of ordinary skill in the art. When the combination of the technical solutions is contradictory or cannot be realized, such a combination of the technical solutions should not be considered to exist, and is not within the protection scope of the present utility model.

The present utility model provides a wheel cover that has a lighting effect. The wheel cover is mounted on the wheels of the bicycle, which can solve the problem in the conventional technology that the light bars need to be wound around the spokes separately and the mounting is complicated.

Specifically, referring to FIGS. 1 to 8, the wheel cover 1 of the present application comprises a sealing disc 10, a light-emitting component 80 arranged on an inner side of the sealing disc 10 and a power supply component 30 mounted on the sealing disc 10, wherein the sealing disc 10 covers the wheel 2, a via 102 for a bottom bracket 21 of the wheel 2 to pass through is formed in the sealing disc 10, the sealing disc 10 is made of a transparent material, the power supply component 30 is electrically connected to the light-emitting component 80, and the light-emitting component 80 is fixed on the inner side of the sealing disc 10. The sealing disc 10 is mounted on and covers the wheel 2, the sealing disc 10 made of a transparent material can transmit the light presented by the light-emitting component 80 on the inside, and the light-emitting component 80 is fixed on the inner side of the sealing disc 10, so that the light-emitting component 80 is mounted on the wheel 2 without wrapping the light bar around the spokes 24. In this way, the mounting is more convenient, the appearance of the wheel 2 is more aesthetic, and the effect of the wheel 2 displayed is cooler. Meanwhile, the sealing disc 10 covers the wheel 2 to protect the wheel during cycling and prevent debris from entering the wheel 2.

Specifically, one side that is of the sealing disc 10 and that is adjacent to the wheel 2 is defined as an inner side, and one side far away from the wheel 2 is defined as an outer side. In an embodiment, the sealing disc 10 comprises a first sealing disc 11 and a second sealing disc 12 respectively positioned at two sides of a hub 22 of a bicycle, the cycling safety can be effectively ensured by respectively arranging the first sealing disc 11 and the second sealing disc 12 on two sides, and the lighting effect of the wheel 2 is more attractive. Of course, only one sealing disc 10 may be provided on a left side or a right side of the wheel 2, the light-emitting component 80 is fixed on an inner side of the corresponding sealing disc 10, and the light is mainly displayed on a corresponding side. The sealing disc 10 is made of a transparent material, and herein, the transparent material is a light-permeable material, including transparent and translucent materials, and specifically may be a light-permeable PVC material.

Further, the lighting effect of wheel 2 is presented, and the mounting of light bars is facilitated. In this embodiment, the light-emitting component 80 comprises a connection terminal 81 and at least two light strips 82, and the at least two light strips 82 are connected in series or in parallel through the connection terminal 81. Specifically, two light strips 82 can be provided, and the two light strips 82 are arranged on one side of the sealing disc 10 in series. Alternatively, the two light strips 82 are respectively arranged on the corresponding first sealing disc 11 and the second sealing disc 12, and the two light strips 82 can be connected in the same power supply component 30 in parallel. The mounting of the light strip 82 can be facilitated by the connection terminal 81. The selected light strip 82 can be a monochromatic light source or a colorful light source, preferably a colorful light source, the beads on the light strip 82 are uniformly distributed, and one end of the light strip 82 is connected to the power supply component 30.

Further referring to FIG. 9, specifically, the connection terminal 81 comprises a plug interface 811 and a plug slot 812, the plug interface 811 may be arranged on one of the light strips 82, the plug slot 812 is arranged on the other light strip 82, and the light strips 82 are spliced by the combination of the plug interface 811 and the plug slot 812, so that the light strips 82 are conveniently mounted. The shapes of the plug slot 812 and the plug interface 811 are not necessarily the same as those of FIG. 9, and are within the scope of this embodiment as long as the same functions can be achieved. Meanwhile, the corresponding fastening mode also belongs to the scope defined in this embodiment.

Further, for the wheel cover 1 of the present application, the inner side of the sealing disc 10 is provided with the groove 70, and the light-emitting component 80 is fixed in the groove 70, so that the overall wheel cover 1 is tidier and easier to mount. The light-emitting component 80 may also be fixed to the inner side of the sealing disc 10 through glue dispensing.

The power supply component 30 is arranged on the first sealing disc 11, the power supply component 30 comprises a battery box 31 and a battery (not shown in the figure), the battery box 31 comprises a placement groove (not shown in the figure) recessed toward a side of the wheel 2 and a sealing cover (not shown in the figure) flush with an outer surface of the sealing disc 10, a first through hole 32 for the light-emitting component 80 to pass through is further formed in a bottom of the placement groove, and the first through hole 32 is configured for the light strip 82 to pass through.

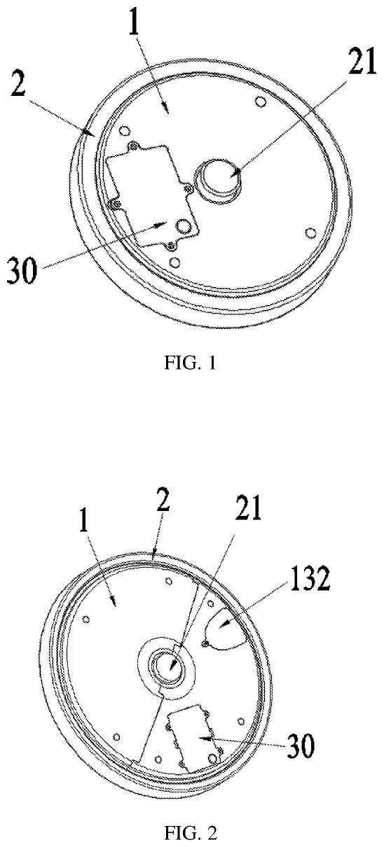

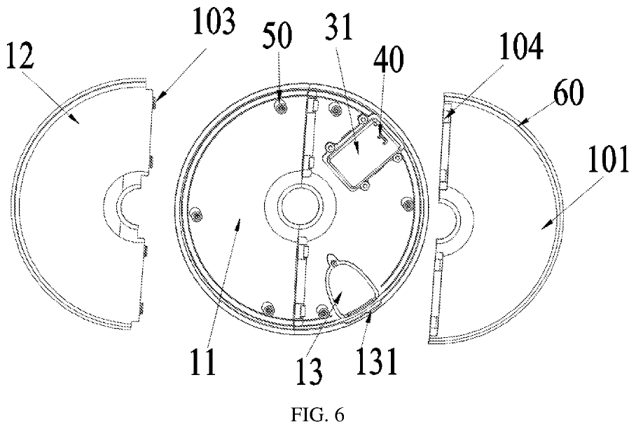

In another embodiment, referring to FIGS. 2 and 6, since an outer diameter of the sealing disc 10 is large, especially for a bicycle with a large wheel diameter, which is inconvenient to transport, the sealing disc 10 is configured into a spliced-type disc, which can effectively reduce the space occupied by transportation, thereby saving the transportation cost. Specifically, the first sealing disc 11 and the second sealing disc 12 may comprise at least two connecting units 101 that are spliced, and the connecting units 101 that can be spliced may be detached to save space during transportation. Among the adjacent connecting units 101, one of which can be provided with a clamping buckle 103, and the other can be provided with a clamping slot 104; and the connecting units 101 can be connected to each other by the engagement of the clamping slot 104 and the clamping buckle 103 to form the complete sealing disc 10. Specifically, the first sealing disc 11 and the second sealing disc may be two semicircular connecting units 101, one of the connecting units 101 is provided with a clamping buckle 103, the other connecting unit 101 is provided with a clamping slot 104, and the two connecting units 101 are connected and spliced through the clamping buckle 103 and the clamping slot 104 to form the circular sealing disc 10. Alternatively, the first sealing disc 11 may be formed by three sector-shaped connecting units 101, and the sealing disc 10 may be formed by splicing three sector-shaped connecting units 101, each of which has a clamping buckle 103 and a clamping slot 104 at a connection with an adjacent connecting unit, or by other splicing patterns.

Further referring to FIGS. 5, 7 and 8, for a bicycle with a large wheel diameter, such as an adult bicycle and a mountain bicycle, the bicycle is basically provided with spokes 24 and correspondingly uses the inflated wheels 2, and for this purpose, a hole 13 may be provided on a position of the first sealing disc 11 corresponding to the valve stem 23 to facilitate the inflation of the wheel 2. Furthermore, the inner side of the first sealing disc 11 may further be provided with a clamping platform 131 for clamping the valve stem 23, the clamping platform 131 is positioned at a lower side of the hole 13, and the arrangement of the clamping platform 131 and the hole 13 can achieve the inflation of the wheels 2 without disassembling the sealing disc 10 and can ensure the alignment of the positions. Furthermore, the sealing disc 10 covers the wheel rim, and a flange 60 clamped with the wheel rim can be arranged on the outer side of the sealing disc 10, so that the wheel cover 1 is prevented from falling off from the wheel 2.

The hole 13 is preferably tapered, and the tapered shape is an arc transition, which prevents cuts when inflating the wheel 2 and makes the wheel more aesthetic. Meanwhile, a cover plate 132 may be arranged on the hole 13 to ensure the aesthetic appearance and the dustproof effect of the outer surface of the entire sealing disc 10.

For the wheel cover 1 of the present application, the wheel cover 1 and the wheel 2 are fixed to rotate together. Furthermore, to facilitate the fixing between the wheel cover 1 and the wheel 2 and prevent the relative movement thereof, the inner side of the sealing disc 10 is provided with an abutment member 40 for the wheel component, correspondingly, the abutment member may abut against the hub 22 and/or the spoke 24, and one or more abutment members 40 is provided, and may be provided on the first sealing disc 11 or the second sealing disc 12 or both the first sealing disc 11 and the second sealing disc 12.

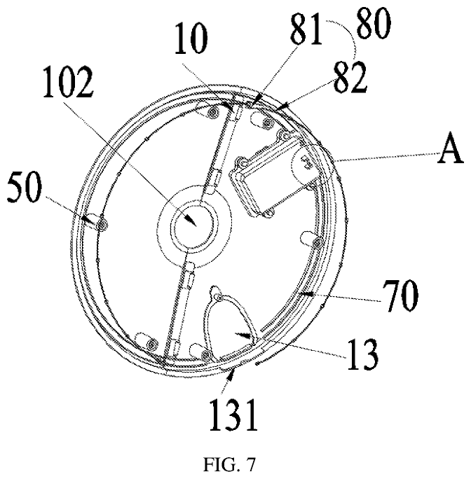

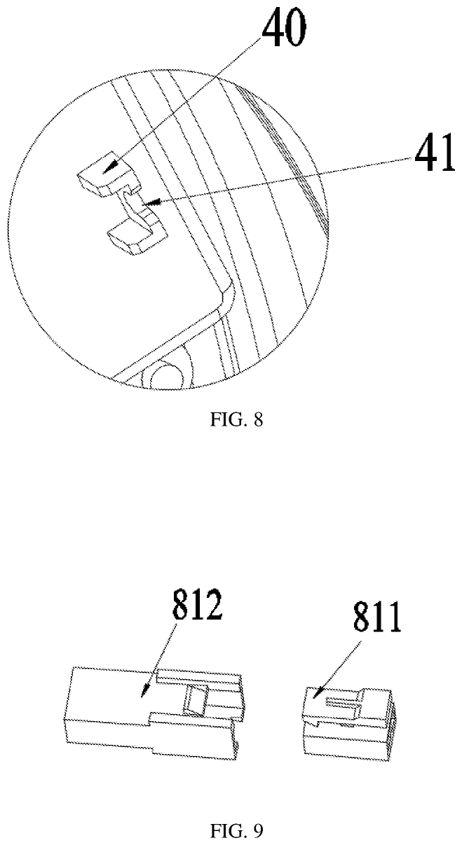

Referring to FIGS. 7 and 8, for the wheel 2 with a large wheel diameter, in this embodiment, the abutment member 40 may be arranged on a side that is of the battery box 31 and that is adjacent to the wheel 2, and the abutment member 40 is provided with a notch 41 for abutting against the spoke 24. Alternatively, the abutment member 40 may be provided on another position, a lower end is an upright post, and an upper is provided with the notch 41.

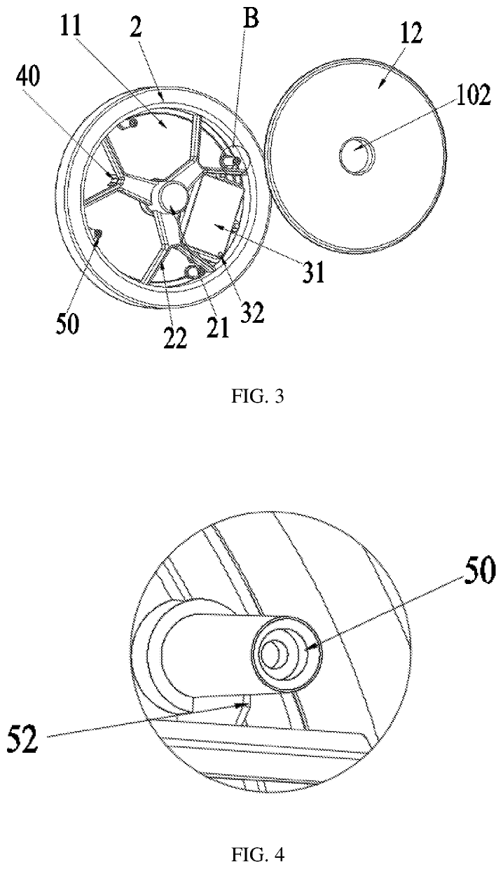

Further, referring to FIG. 3, for a bicycle with a smaller wheel diameter, such as a children's bicycle and a children's balance bike, the structure of the large hub 22 is basically adopted, the spokes 24 are not provided, and the corresponding abutment members 40 are arranged at the inner side that is of the sealing disc 10 and corresponds to a corner position where the hub 22 is spliced and are shaped into an adapted central inwardly curved concave shape. The abutting position can be effectively positioned and fixed, and relative movement between the wheel cover 1 and the wheel 2 is prevented.

Furthermore, a plurality of first connecting members are arranged on an inner side of the first sealing disc 11, a plurality of second connecting members are correspondingly arranged on an inner side of the second sealing disc 12, and the first sealing disc 11 and the second sealing disc 12 are fixed by the first connecting members and the second connecting members.

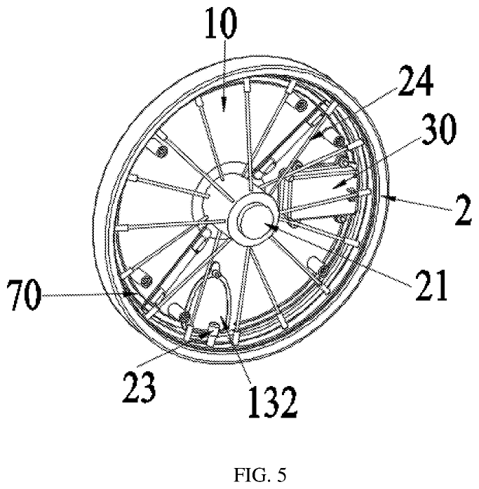

Referring to FIG. 4, specifically, the first connecting member is an inserting post 50, and the second connecting member is an inserting aperture (not shown in the figures), wherein an outer edge of the inserting post 50 or the inserting aperture is provided with side wings 51 for abutting against an inner edge of the wheel 2, wherein the height of the side wings 51 is lower than that of the insertion post 50 or the corresponding inserting aperture. In other embodiments, the first connecting member and the second connecting member may be a combination of screw holes and screws.

The present utility model further provides a bicycle wheel 2, wherein the bicycle wheel 2 comprises a wheel cover 1. For the specific structure of the wheel cover 1, refer to the foregoing embodiment. Since the bicycle wheel 2 provided by the present utility model comprises all the solutions of all the embodiments of the wheel cover 1, at least the same technical effects as the wheel cover 1 are obtained, and this is not described one by one herein. It should be noted that a balance bike and the like are included in the scope of the bicycle.

The above mentioned contents are only optional embodiments of the present utility model and are not intended to limit the patent scope of the present utility model, and under the inventive concept of the present utility model, the equivalent structural transformations made by using the contents of the specification and the drawings of the present utility model, or direct/indirect applications to other related technical fields, are all included in the patent protection scope of the present utility model.

1. A wheel cover, arranged on a wheel of a bicycle, and comprising: a sealing disc, a light-emitting component arranged on an inner side of the sealing disc and a power supply component mounted on the sealing disc, wherein the sealing disc covers the wheel, a via for a bottom bracket to pass through is formed in the sealing disc, the sealing disc is made of a transparent material, the power supply component is electrically connected to the light-emitting component, and the light-emitting component is fixed on the inner side of the sealing disc.

2. The wheel cover according to claim 1, wherein the sealing disc comprises a first sealing disc and a second sealing disc respectively positioned at two sides of a hub of the bicycle, the light-emitting component comprises a connection terminal and at least two light strips, and the at least two light strips are connected in series or in parallel through the connection terminal.

3. The wheel cover according to claim 2, wherein the connection terminal comprises a plug interface and a plug slot.

4. The wheel cover according to claim 2, wherein each of the first sealing disc and the second sealing disc comprises at least two connecting units that are spliced, a clamping buckle and a clamping slot are arranged between adjacent connecting units, and the connecting units are connected and spliced by the clamping buckle and the clamping slot to form the sealing disc.

5. The wheel cover according to claim 4, wherein the first sealing disc is provided with a hole corresponding to a position of a valve stem of the wheel, the inner side of the first sealing disc is provided with a clamping platform for clamping the valve stem, and the clamping platform is arranged on a lower side of the hole.

6. The wheel cover according to claim 2, wherein the power supply component is arranged on the first sealing disc, the power supply component comprises a battery box and a battery, the battery box comprises a placement groove recessed toward a side of the wheel and a sealing cover flush with an outer surface of the sealing disc, and a first through hole for the light-emitting component to pass through is further formed in a bottom of the placement groove.

7. The wheel cover according to claim 6, wherein at least one of the first sealing disc or the second sealing disc is provided with an abutment member, the abutment member is arranged on an inner side of the sealing disc, and the abutment member is configured to abut against a component of the wheel.

8. The wheel cover according to claim 7, wherein the abutment member is arranged at a side that is of the battery box and that is adjacent to the wheel, and the abutment member is provided with a notch for abutting against the spoke.

9. The wheel cover according to claim 2, wherein a plurality of first connecting members are arranged on an inner side of the first sealing disc, a plurality of second connecting members are correspondingly arranged on an inner side of the second sealing disc, and the first sealing disc and the second sealing disc are fixed by the first connecting members and the second connecting members.

10. The wheel cover according to claim 9, wherein the first connecting member is an inserting post, and the second connecting member is an inserting aperture, wherein an outer edge of the inserting post or the inserting aperture is provided with side wings for abutting against an inner edge of the wheel.

11. The wheel cover according to claim 2, wherein a groove is provided on the inner side of the sealing disc, and the light-emitting component is fixed in the groove.

12. The wheel cover according to claim 3, wherein the sealing disc is provided with a flange for clamping with a wheel rim.

13. The wheel cover according to claim 1 further comprising a bicycle wheel.
